(19) United States
(12) Patent Application Publication
(10) Pub. No.: US 2013/0231187 A1
(43) Pub. Date: Sep. 5, 2013

(54) METHOD OF UTILIZING A MOBILE COMMUNICATION DEVICE AS A GAMING CONTROLLER

(71) Applicants: INVENTEC APPLIANCES (PUDONG) CORPORATION, Shanghai (CN); INVENTEC APPLIANCES CORP., New Taipei (TW); INVENTEC APPLIANCES (SHANGHAI) CO. LTD., Shanghai (CN)

(72) Inventor: Long Pu, Shanghai (CN)

(73) Assignees: INVENTEC APPLIANCES (PUDONG) CORPORATION, Shanghai (CN); INVENTEC APPLIANCES (SHANGHAI) CO. LTD., Shanghai (CN); INVENTEC APPLIANCES CORP., New Taipei (TW)

(21) Appl. No.: 13/779,377

(22) Filed: Feb. 27, 2013

(30) Foreign Application Priority Data
Mar. 1, 2012 (CN) 201210051780.3

(51) Int. Cl. A63F 13/06

(52) U.S. Cl. CPC A63F 13/06
USPC 463/37

(57) ABSTRACT

The present invention relates to a method of utilizing a mobile communication device as a gaming controller, applicable to a game system with the mobile communication device and a computing device. The mobile communication device is configured to produce a sensing signal upon sensing the mobile communication device's state of being positioned. The sensing signal is analyzed to obtain a control signal including a control instruction corresponding to a control key code produced by an input device connected to the computing device. After receiving a transmitting packet to which the control signal is converted, the computing device derives a version of the control signal from the transmitting packet and then performs an operation in a game process, corresponding to the control key code, according to the control instruction obtained from the version of the control signal, and the frequency of the obtained control instruction.

### CROSS-REFERENCE TO RELATED APPLICATIONS

This non-provisional application claims priority under 35 U.S.C. §119(a) on Patent Application No(s). 201210051780.3 filed in China on Mar. 1, 2012, the entire contents of which are hereby incorporated by reference.

### FIELD OF THE INVENTION

The present invention relates to a method of utilizing a mobile communication device as a gaming controller, applicable to a game system with the mobile communication device and a computing device, and more particularly relates to a method of utilizing a mobile communication device as a gaming controller to control a game process in the game system with the computing device.

### BACKGROUND OF THE INVENTION

Attending with rapid progressing of technology and vigorous development of economic, electronic gaming industry experienced a phenomenal growth in the last decade. Various game stations emerged in the market, such as WII, XBOX, and etc., and the game types become more diverse, e.g. motion sensing game, which is capable of sensing the motion of the players. However, because price of the game station is still high, the gaming stations are less widespread than the ordinary home computing devices. Thus, when the manufacturer of game station usually develops certain games, a PC compatible version in additional to the game station compatible version is usually designed to expand the targeting clients. However, attending with the highly refinement of games, the players may encounter lots of inconveniences when playing the games originally designed to run on the game stations by using the computing device, which are described below:

(1) Difficulty in handling: Generally, the main input device of computing device is the keyboard. The player cannot rapidly and intuitively input the wanted movement when using the keyboard to input the control instructions. For example, in the car racing game, the player needs to change the moving direction of the racing car rapidly in response to the curvature of the racing lanes. When using the keyboard to do the operation, the player usually needs to press the keys rapidly and continuously to achieve the wanted operation, which may result in fatigue of player's hand and badly influence the player's performance.

(2) Need to purchase a gaming controller: In order to resolve the problem of difficulty in handling as mentioned above, the player may purchase the specific gaming controller to enhance operating fluency when playing games. However, many games are designed to play on a specific game station. In order to experience the full version of the game, the player usually needs to purchase a specific gaming controller with the special sensing unit provided by the gaming company to play the game, e.g. the gaming controller with a gyro sensor to sense the movement of the player. As a result, the player needs to pay more for the gaming controller. On the other hand, the willingness of the player to buy the gaming controller may be hindered because such gaming controller might only be used in the games provided by the specific gaming company.

(3) Limitations of gaming controller: As mentioned above, even with the willingness to buy the gaming controller for playing games on the computing device, most of the gaming controllers on the market are provided with an operating method similar to PC's keyboard, which may result in the problem of difficulty in handling as well. Even there exist some high-end gaming controllers embedded with sensing units, the price is usually high, and such gaming controller is usually only suitable for certain games.

Because the development of electronic technology in recent years, mobile communication devices have become necessary and widely used in daily life. Most of the mobile communication devices are provided with sensing units, such as a gyro sensor, horizon sensor, optical sensor, magnetic sensor, etc., which are capable of detecting the mobile communication device's state of being positioned. Accordingly, the inventor noticed that the operational inconvenience of conventional game system might be resolved if the characteristics of the sensing units in the mobile communication device can be properly used to integrate, analyze and process the sensing signals therefrom so as to have the computing device correctly and fluently control the game based on the sensing signals just like the computing device reads the signals from the gaming controller or the keyboard. Thus, how to use the sensing signals from the sensing units of the mobile communication device efficiently and do the corresponded adjustment to enable the computing device to execute the respective movement, is an important problem to be resolved.

### BRIEF SUMMARY OF INVENTION

In view of the problem that the player needs to purchase a gaming controller for playing certain games, a method of utilizing a mobile communication device as a gaming controller is provided in accordance with the present invention for improving difficulty in handling the game system.

It is an object of the present invention to provide a method of utilizing a mobile communication device as a gaming controller. This method is applicable to a game system with the mobile communication device and a computing device. The mobile communication device comprises a computing module and a communication module. The computing device is electrically connected to an input device having a plurality of keys thereon, such as the keyboard. The mobile communication device is configured to produce a sensing signal upon sensing the mobile communication device's state of being positioned. The input device is configured to produce a control key code, when each of the plurality of keys is depressed, for the computing device to control a game process. The method comprises transmitting the sensing signal to the computing module; the computing module analyzing the sensing signal to obtain a control signal, the control signal including a control instruction corresponding to the control key code, and a frequency of the control instruction; the communication module wirelessly transmitting a transmitting packet to which the control signal is converted to the computing device; the computing device deriving a version of the control signal from the transmitting packet; and the computing device performing an operation in the game process, corresponding to the control key code, according to the control instruction obtained from the version of the control signal, and the frequency of the obtained control instruction.

The present invention also provides a method of utilizing a mobile communication device as a gaming controller, applicable to a game system with the mobile communication device and a computing device, wherein the mobile communication device comprises a sensing unit, a computing module, and a communication module. The computing device is electrically connected to an input device having a plurality of keys thereon. The mobile communication device is configured to produce a sensing signal upon the sensing unit sensing the mobile communication device's state of being positioned. The input device is configured to produce a control key code, when each of the plurality of keys is depressed, for the computing device to control a game process. And the method comprises transmitting the sensing signal to the computing module; the computing module analyzing the sensing signal to obtain a control signal, the control signal including a control instruction corresponding to the control key code, and a frequency of the control instruction; the communication module wirelessly transmitting a transmitting packet, to which the control signal is converted, to the computing device; the computing device deriving a version of the control signal from the transmitting packet; and the computing device performing an operation in the game process, corresponding to the control key code, according to the control instruction obtained from the version of the control signal, and the frequency of the obtained control instruction.

Advantages of the present invention may include, but are not limited to, that the player doesn't need to purchase a gaming controller for playing certain games or do any manually settings on the computing device. He can simply wirelessly connect the mobile communication device to the computing device, and then the mobile communication device can be configured to operate a character and control its movement in the game process in a more accurate and sensitive way through using the sensing unit in the mobile communication device.

In various embodiments, the above step of transmitting the sensing signal to the computing module may be performed when variation of the sensing signal is detected.

In various embodiments, the computing device may comprise a receiving module and a control module, wherein the receiving module is configured to receive the transmitting packet, and the control module is to be used by the computing device to perform the operation according to the version of the control signal. And the method may further comprise the step of the receiving module transmitting an interrupt signal to the control module, upon deriving a version of the control signal, in order for the control module to perform the operation according to the version of the control signal. An advantage of performing this step of transmitting an interrupt signal before the receiving module transmits the control instruction obtained from the version of the control signal to the control module may be to make it a priority for the control module to act on the control instruction, ensuring that the control signal can be used to control the game process in real time.

Advantages of the present invention also may include that according to the mobile communication device's design direction and needs, providers of the mobile communication device may select one of different types of sensing units (including for example a gyro sensor, accelerometer, etc. respectively), and the respective detecting parameters, such as deflection direction, acceleration, etc., to produce the sensing signal such that the player can feel more real in playing games by utilizing the mobile communication device as a gaming controller.

The embodiments of the present invention will be further discussed in the following paragraphs and the figures for better understanding.

### BRIEF DESCRIPTION OF THE DRAWINGS

FIG. 1 illustrates a game system with a mobile communication device and a computing device, to which system the present invention may be applied.

FIG. 2 is a flowchart showing an operation process of the mobile communication device in a preferred embodiment of the present invention.

FIG. 3 is a flowchart showing an operation process of the computing device in a preferred embodiment of the present invention.

### DETAILED DESCRIPTION OF THE INVENTION

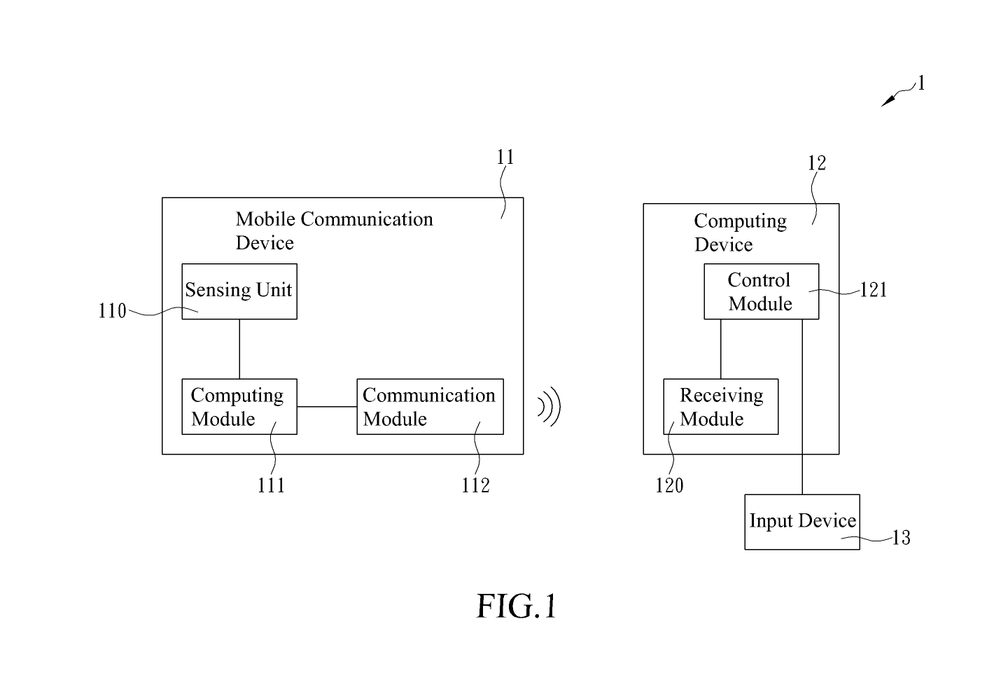

The present invention relates to a method of utilizing a mobile communication device as a gaming controller (or otherwise called a gaming control or handle). This method is applicable to a game system. FIG. 1 illustrates a game system with a mobile communication device and a computing device, to which system the method of the present invention may be applied. Referring to FIG. 1, the game system includes or is with at least a mobile communication device 11 and a computing device 12. The computing device 12 may be any computing device suitable or adapted for the game system, and may be for example a computer, a gaming apparatus, or other electronic computing device. The mobile communication device 11 has a sensing unit 110, a computing module 111, and a communication module 112. The mobile communication device 11 or sensing unit 110, which includes for example a gyro sensor, is configured to produce a sensing signal upon sensing the mobile communication device's state of being positioned. And the sensing signal may accord with the mobile communication device's arranged position, deflection angle, or deflection direction. The computing module 111 is electrically connected to the sensing unit 110 and the communication module 112 respectively.

Also referring to FIG. 1, the computing device 12 comprises a receiving module 120 and a control module 121, and is electrically connected to an input device 13 (such as a keyboard). The input device 13 has a plurality of keys thereon. When the user depresses each of the plurality of keys, the input device 13 is configured to produce a respective control key code and transmit the control key code to the control module 121 of the computing device 12 to perform a respective action or operation in or to control a game process (e.g. in a car racing game, when the key [A] of the input device 13 is depressed, the car will turn left).

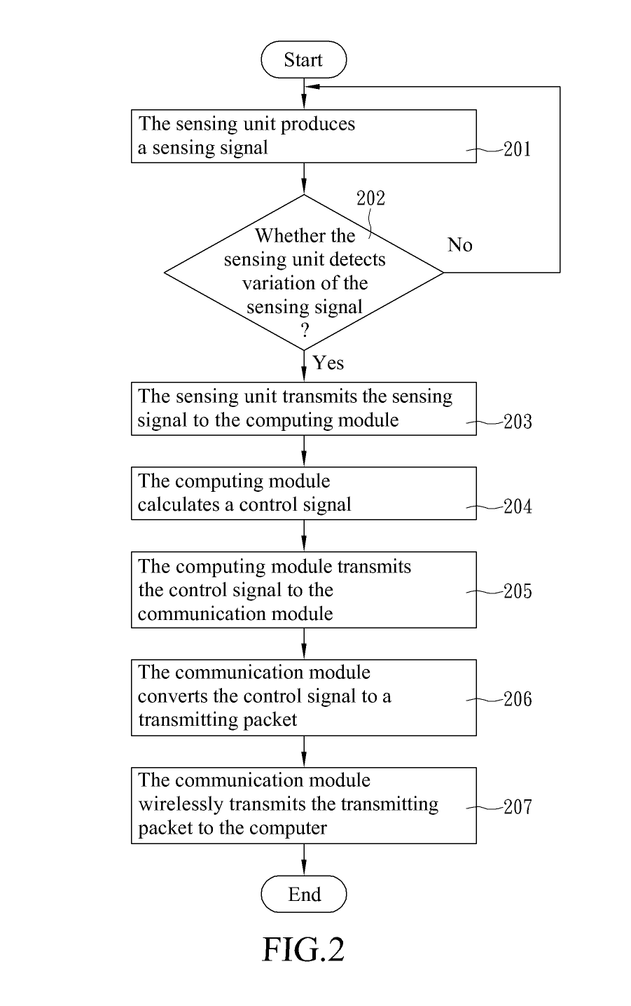

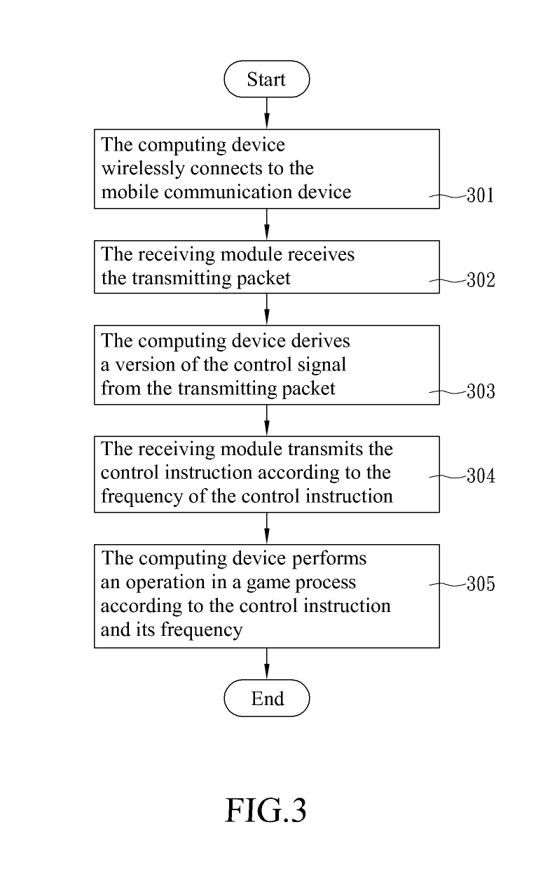

FIG. 2 is a flowchart showing an operation process of the mobile communication device in a preferred embodiment of the present invention. FIG. 3 is a flowchart showing an operation process of the computing device in a preferred embodiment of the present invention. Referring to FIGS. 1-3, a car racing game is taken as an example for describing the operation process of both the mobile communication device 11 and the computing device 12 in an embodiment of applying the method of the present invention.

At step (201) of this embodiment, the sensing unit 110 produces a sensing signal according to and upon sensing the mobile communication device 11's state of being positioned (e.g. deflection direction or deflection angle of the mobile communication device 11).

At step (202) of this embodiment, the sensing unit 110 detects whether the sensing signal has varied (for example whether it is identical to the sensing signal at an earlier time such as 1 second ago). If yes, proceed to step (203), or otherwise back to step (201).

At step (203) of this embodiment, the sensing unit 110 transmits the sensing signal to the computing module 111. In the present embodiment, the sensing signal includes or is produced based on a deflection direction (value) and a deflection angle (value) of the mobile communication device 11.

At step (204) of this embodiment, the computing module 111 analyzes the sensing signal to obtain a control signal, according to the deflection direction (value) and the deflection angle (value). The step of analyzing the sensing signal includes any possible appropriate way of examining the sensing signal and has appropriate meaning in the broad senses of “analyze”, as known or understood by one of ordinary skill in the art of electronic or communication devices. The control signal includes a control instruction and a frequency of the control instruction. The control instruction corresponds to one of the control key codes. For example, upon the sensing unit 110 detecting that the mobile communication device deflects downward to the left with a deflection angle of 15 degrees, the computing module 111 calculates that the control instruction should correspond to the control key code for the key [A] of the input device being depressed, and that the frequency of the control instruction should be the frequency of depressing the key [A] 3 times per second. It's noted that the frequency of the control instruction may be specified in the control instruction, or may be the number of repetitions of the control instruction itself. Therefore the obtained control signal corresponds to the operation of depressing key [A] on the input device with the frequency of 3 times per second, in a game process.

At step (205) of this embodiment, the computing module 111 transmits the control signal to the communication module 112;

At step (206) of this embodiment, the communication module 112 converts the control signal to a transmitting packet.

At step (207) of this embodiment, the communication module 112 wirelessly transmits (by means of Wi-Fi, Bluetooth, or other standards) the transmitting packet to the computing device 12.

Referring to the description above and FIGS. 1-3, in this embodiment, the operation process of the computing device 12 includes the following steps:

At step (301) of this embodiment, the computing device 12 wirelessly connects to the mobile communication device 11 through for example the receiving module 120.

Then the computing device 12 receives the transmitting packet from the mobile communication device 11. This is implemented for example by step (302) of this embodiment, at which the receiving module 120 receives the transmitting packet from the communication module 112 of the mobile communication device 11.

Then the computing device 12 derives a version of the control signal from the transmitting packet. This is implemented for example by step of this embodiment, at which the receiving module 120 analyzes the transmitting packet to derive or obtain a version of the control signal. Whether or not at the receiving module 120, a control instruction and a frequency of the control instruction can be obtained from the version of the control signal. It's noted that the version of the control signal is based on the original control signal and may be different to some degree from the original control signal.

At step (304) of this embodiment, the receiving module 120 transmits the obtained control instruction to the control module 121 with the obtained frequency of the control instruction.

And then the computing device performs an operation in the game process, corresponding to the control key code, according to the control instruction obtained from the version of the control signal, and the frequency of the obtained control instruction. The operation may be performed according to the obtained control instruction and with the frequency of the obtained control instruction. This step of the computing device performing an operation is implemented for example by step (305) of this embodiment. At step (305), after receiving the control instruction, the control module 121 causes the computing device 12 to perform an operation (for example, to cause the racing car to turn left) in the game process, corresponding to the control key code, according to the control instruction and its frequency obtained from the version of the control signal.

Therefore, also referring to FIGS. 1 to 3, in a preferred embodiment of the method of the present invention, the sensing signal is analyzed to obtain the control signal corresponding to the control key code, the player does not need to purchase a specific gaming controller or gaming handle when playing certain games or do any manually settings on the computing device 12. What he needs to do is to wirelessly connect the mobile communication device 11 to the computing device 12, and then the mobile communication device 11 can be configured to give the control instruction through the usage of the sensing unit 110 therein in a more sensitive and intuitive way. In addition, since the computing module 111 is configured to analyze the sensing signal to obtain the control signal corresponding to the control key code, the derived version of the control signal including the control instruction for the computing device 12 would correspond to the control key code to be produced by the input device 13. Thus, the control module 121 can cause the computing device 12 to perform an operation in the game process, corresponding to the control key code, according to the control instruction and its frequency, which can prevent incompatibilities between the computing device 12 and the mobile communication device 11 in controlling the game process. This advantage not only enhances convenience and flexibility when operating and controlling the game system but also largely expands the application and function of the mobile communication device 11.

In addition, referring to FIG. 1, in this embodiment, after the receiving module 120 receives and then analyzes the transmitting packet to derive a version of the control signal, the receiving module 120 may be configured to generate and transmit a registration message to the control module 121 to register a virtual input device on the computing device 12 corresponding to the input device 13. Then, the receiving module 120 can also transmit an interrupt signal to the control module 121 such that the control module 121 treats the control instruction transmitted from the receiving module 120 according to the version of the control signal first.

Moreover, in the above mentioned embodiment, the sensing unit 110 includes a gyro sensor, which is capable of producing a sensing signal based on the present deflection angle and deflection direction of the mobile communication device 11. However, in accordance with other embodiments of the present invention, the sensing unit 110 is not so limited. The sensing unit 110 may include an accelerometer, which is capable of detecting a moving direction (value) and an acceleration (value) of the mobile communication device 11, based on either one a corresponding sensing signal can be produced. For example, in a bowling game run on the game system, the accelerometer of the mobile communication device can be used to calculate the direction and power of the ball thrown by the player to give a better feeling of reality.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A method of utilizing a mobile communication device as a gaming controller, applicable to a game system with the mobile communication device and a computing device, the mobile communication device comprising a computing module and a communication module, the computing device being electrically connected to an input device having a plurality of keys thereon, wherein the mobile communication device is configured to produce a sensing signal upon sensing the mobile communication device's state of being positioned, the input device is configured to produce a control key code, when each of the plurality of keys is depressed, for the computing device to control a game process, and the method comprises:
transmitting the sensing signal to the computing module;
the computing module analyzing the sensing signal to obtain a control signal, the control signal including a control instruction corresponding to the control key code, and a frequency of the control instruction;
the communication module wirelessly transmitting a transmitting packet to which the control signal is converted to the computing device;
the computing device deriving a version of the control signal from the transmitting packet; and
the computing device performing an operation in the game process, corresponding to the control key code, according to the control instruction obtained from the version of the control signal, and the frequency of the obtained control instruction.

2. The method of claim 1, wherein the mobile communication device comprises a sensing unit configured to produce the sensing signal.

3. The method of claim 2, wherein the sensing unit comprises a gyro sensor and in the step of analyzing the sensing signal to obtain a control signal, the control signal is obtained according to both a deflection angle and a deflection direction of the mobile communication device, based on which the sensing signal is produced.

4. The method of claim 2, wherein the sensing unit comprises an accelerometer and in the step of analyzing the sensing signal to obtain a control signal, the control signal is obtained according to an acceleration of the mobile communication device, based on which the sensing signal is produced.

5. The method of claim 1, wherein the step of transmitting the sensing signal to the computing module is performed when variation of the sensing signal is detected.

6. The method of claim 1, wherein the computing device comprises a receiving module and a control module, the receiving module is configured to receive the transmitting packet, and the control module is to be used by the computing device to perform the operation according to the version of the control signal.

7. The method of claim 6, wherein the receiving module is configured to contribute to performing the step of deriving a version of the control signal.

8. The method of claim 6, further comprising the receiving module transmitting an interrupt signal to the control module, upon deriving the version of the control signal, in order for the control module to perform the operation according to the version of the control signal.

9. A method of utilizing a mobile communication device as a gaming controller, applicable to a game system with the mobile communication device and a computing device, the mobile communication device comprising a sensing unit, a computing module, and a communication module, the computing device being electrically connected to an input device having a plurality of keys thereon, wherein the mobile communication device is configured to produce a sensing signal upon the sensing unit sensing the mobile communication device's state of being positioned, the input device is configured to produce a control key code, when each of the plurality of keys is depressed, for the computing device to control a game process, and the method comprises:
transmitting the sensing signal to the computing module;
the computing module analyzing the sensing signal to obtain a control signal, the control signal including a control instruction corresponding to the control key code, and a frequency of the control instruction;
the communication module wirelessly transmitting a transmitting packet, to which the control signal is converted, to the computing device;
the computing device deriving a version of the control signal from the transmitting packet; and
the computing device performing an operation in the game process, corresponding to the control key code, according to the control instruction obtained from the version of the control signal, and the frequency of the obtained control instruction.

10. The method of claim 9, wherein the sensing unit comprises a gyro sensor and in the step of analyzing the sensing signal to obtain a control signal, the control signal is obtained according to both a deflection angle and a deflection direction of the mobile communication device, based on which the sensing signal is produced.

11. The method of claim 9, wherein the sensing unit comprises an accelerometer and in the step of analyzing the sensing signal to obtain a control signal, the control signal is obtained according to an acceleration of the mobile communication device, based on which the sensing signal is produced.

12. The method of claim 9, wherein the sensing unit is configured to produce the sensing signal and to perform the step of transmitting the sensing signal to the computing module.

13. The method of claim 9, wherein the step of transmitting the sensing signal to the computing module is performed when variation of the sensing signal is detected.

14. The method of claim 9, wherein the computing device comprises a receiving module and a control module, the receiving module is configured to receive the transmitting packet, and the computing device uses the control module to perform the operation according to the version of the control signal.

15. The method of claim 14, wherein the receiving module is configured to contribute to performing the step of deriving a version of the control signal.

16. The method of claim 14, upon deriving a version of the control signal, further comprising the receiving module transmitting an interrupt signal to the control module in order for the control module to perform the operation according to the version of the control signal.

17. The method of claim 1, wherein the mobile communication device comprises a sensing unit configured to perform the step of transmitting the sensing signal to the computing module.
